(19) United States
(12) Patent Application Publication
(10) Pub. No.: US 2004/0060383 A1
(43) Pub. Date: Apr. 1, 2004

(54) Automatic balancing device and manufacturing method therefor

(75) Inventors: Atushi Honda, Nagano (JP); Hiromi Miyazawa, Nagano (JP)

Correspondence Address: HOGAN & HARTSON L.L.P., 500 S. GRAND AVENUE, SUITE 1900, LOS ANGELES, CA, 90071-2611, US

(73) Assignee: SANKYO SEIKI MFG. CO., LTD.

(21) Appl. No.: 10/632,565

(22) Filed: Aug. 1, 2003

(30) Foreign Application Priority Data
Aug. 12, 2002 (JP) 2002-234415

(51) Int. Cl. F16F 15/22

(52) U.S. Cl. 74/573 R

(57) ABSTRACT

An automatic balancing device includes a hollow housing case body rotated with a rotary body and having an annular space formed inside of the hollow housing case body. A plurality of balance balls are accommodated in the annular space of the hollow housing case body in a freely movable manner so as to cancel an imbalance of the rotary body. A film of a volatile rust preventing agent is formed on a surface of the plurality of balance balls.

### BACKGROUND OF THE INVENTION

1. Field of the Invention

The present invention relates to an automatic balancing device which is constituted to cancel a rotating imbalance of a rotary body and a manufacturing method therefor.

2. Description of Related Art

In a rotational driving device which is commonly used in various kinds of devices such as an industrial machine, a household electric appliance, a computer or the like, an automatic balancing device is often used for canceling a rotating imbalance of a rotary body and restraining vibrations of the rotary body. Various types of automatic balancing devices have been conventionally proposed, and one of which is shown in FIG. 3. In FIG. 3, an automatic balancing device (A) includes a housing case body 3 formed in a hollow annular shape and is mounted to a rotary shaft 2 that is the output shaft of a motor part 1. A plurality of balance balls 4 are accommodated in a freely movable manner in the inside of the housing case body 3 formed in the hollow annular shape, which is provided in the automatic balancing device A.

When the motor part 1 starts rotating at a low speed, the respective balance balls 4 are attracted and held on the outer peripheral face of a hold magnet 5, which is arranged on a center part side of the hollow annular-shaped case 3 in a radial direction. Further, when the number of revolutions of the motor part 1 exceeds the number of resonant rotation CR, the respective balance balls 4 begin to be separated from the hold magnet 5 on an outer side in the radial direction. Then, the respective balance balls 4 move in an opposite direction to the position of the center of gravity of the rotary body, which includes the rotary shaft 2 and the automatic balancing device (A). In other words, the balance balls 4 move to a position canceling a rotating imbalance of the rotary body for performing an automatic balancing operation which cancels the imbalance of the rotary body during rotation. By such a balancing operation with the use of the balance balls 4, the vibrations of the rotary body are reduced and the rotating state of the rotary body is stabilized.

The balance ball 4 is formed of steel and has a magnetism in order to prevent generation of noise due to the collision of the balance balls 4. The magnetic balance balls 4 are repulsive to each other due to the magnetic flux generated from the hold magnet 5. There are various types of materials that can be utilized as a steel ball for the balance ball, but chrome steel is commonly used because it is a magnetic substance having an adequate density and less residual magnetic flux.

The balance balls formed with chrome steel easily rust and before assembling, the balls are preserved in a rust preventive oil having a high viscosity. For example, the balls are preserved in the rust preventive oil after they have been delivered. However, when the balance balls are put in the hollow housing case body and used under the condition that the rust preventive oil is attached to the balance balls, the frictional resistance of the balance balls increase due to the rust preventive oil and the movement of the balance balls do not perform smoothly. Therefore, the above-mentioned vibrational restraint may be lowered.

Accordingly, processes of degreasing, cleaning and drying the balance balls 4 have been conventionally performed before putting the balance balls into the housing case body. However, a cleaning liquid is endothermically evaporated during the drying process after the degreasing and cleaning process, and thus dew condensation occurs on the surface of the balance balls and rust may be generated. Further, on the contrary, when degreasing is completely executed by the degreasing and cleaning process, the frictional resistance of the balance balls become rather large causing poor movement of the balance balls. Consequently, the vibrational restraint is reduced.

As described above, even in the case the rust preventive oil is left too much on the surface of the balance balls, or even when the degreasing is completely performed, the vibrational restraint is lowered in any case. On the other hand, if a uniform oil film of micron unit is formed on the surface of the balance balls in a film shape, a rust preventing effect and a vibrational restraint may be satisfactorily attained. However, in each of the conventional degreasing cleaning, and drying processes, performing such highly precise processes is extremely difficult due to fluctuations occurring in mass production.

### SUMMARY OF THE INVENTION

In view of the problems described above, it is advantage of the present invention to provide an automatic balancing device and a manufacturing method for an automatic balancing device, capable of forming a film of a uniform and thin layer on the surface of a balance ball.

In accordance with an embodiment of the present invention, there is provided an automatic balancing device including a plurality of balance balls, on each surface of which a thin film of a volatile rust preventing agent is formed.

In accordance with another embodiment of the present invention, there is provided an automatic balancing device including a surface, on which a plurality of balance balls move or are in contact, formed with a thin film of a volatile rust preventing agent thereon.

According to such an automatic balancing device, the vapor of the volatile rust preventing agent, which is slowly vaporized at room temperature, is attached to the surface of the respective balance balls or the surface on which the balance balls move or are in contact. Consequently, the film of the volatile rust preventing agent is formed in a uniform and thin film shape, and thus the rust prevention for the balance balls and the vibrational restraint for the rotary body can be obtained in an extremely satisfactory manner.

In accordance with an embodiment of the present invention, the automatic balancing device is provided with a plurality of balance balls respectively formed of steel and having a magnetism, and a hollow housing case body, in which a magnet body exerting a magnetic action so that the respective steel balls can be repulsive to each other is arranged. The automatic balancing device may be constituted in such a manner that the space in which the magnet body is arranged and the annular space in which the balance balls are accommodated are formed in a communicated and sealed annular space and the magnet body is impregnated with a volatile rust preventing agent.

According to the automatic balancing device having such a constitution, the volatile rust preventing agent impregnated in the magnet body slowly vaporizes at room temperature and is attached on the surface of the respective balance balls after assembling. Therefore, the film of the volatile rust preventing agent can be formed in a uniform and thin film shape, and thus the rust prevention for the balance balls and the vibrational restraint for the rotary body can be obtained in an extremely satisfactory state.

In other words, even though the film of the volatile rust preventing agent is not formed in advance on the surface of the balance balls or the surface on which the balance balls move, when the vaporized volatile rust preventing agent is filled in the annular space formed by the hollow housing case body, in which the balance balls are placed in a movable manner, the vaporized volatile rust preventing agent is afterward attached on the surface of the respective balance balls or the surface on which the balance balls move. Therefore, also in this case, the film of the volatile rust preventing agent can be formed in a uniform and thin film shape.

In accordance with an embodiment of the present invention, there is provided a manufacturing method for an automatic balancing device including a step for cleaning a plurality of balance balls immersed in a rust preventive oil, a step for placing the balance balls, after cleaning, in an atmosphere of a volatile rust preventing agent, and a step for forming a film of the volatile rust preventing agent on the surface of the respective balance balls, and then the balance balls are accommodated in an annular space of a hollow housing case body.

According to such a manufacturing method for an automatic balancing device, the vapor of the volatile rust preventing agent, which is slowly vaporized at room temperature, is attached on the surface of the respective balance balls. Therefore, the film of the volatile rust preventing agent can be formed in a uniform and thin film shape, and thus the rust prevention for the balance balls and the vibrational restraint for the rotary body can be obtained in an extremely satisfactory state.

In the manufacturing method of the automatic balancing device, it is preferable to form the film of the volatile rust preventing agent on the surface of the balance ball by utilizing an easy reacting condition of the ball at the time of the drying process after cleaning.

According to such a manufacturing method for an automatic balancing device, on endothermical evaporating effect at the time of drying the cleaning liquid from the balance ball, which is under an easy reacting condition, is utilized to form the film of the volatile rust preventing agent. Therefore, the vapor of the volatile rust preventing agent which is slowly vaporized at room temperature is attached on the surface of the balance ball instead of forming dew condensation. Accordingly, the conventional occurrence of rust due to dew condensation is prevented.

Also, in accordance with another embodiment of the present invention, there is provided a manufacturing method for an automatic balancing device including a step of providing a plurality of balance balls respectively formed of steel and having a magnetism, a step of providing a hollow housing case body having a sealed annular space including an annular space for the steel balance balls and an annular space for disposing a magnet body capable of exerting a magnetic action so that the steel balance balls are repulsive to each other, the two annular spaces being formed so as to be communicated with each other, a step of disposing the magnet body impregnated with a volatile rust preventing agent in the annular space of the hollow housing case body, and a step of forming a film of the volatile rust preventing agent on the surface of the respective steel balance balls or the surface on which the steel balance balls move.

According to such a manufacturing method for an automatic balancing device, the volatile rust preventing agent impregnated in the magnet body slowly vaporizes at room temperature and is attached on the surface of the respective steel balance balls after being assembled. Therefore, the film of the volatile rust preventing agent can be formed in a uniform and thin film shape, and thus the rust prevention for the balance balls and the vibration restraintal for the rotary body can be obtained in an extremely satisfactory state.

Other features and advantages of the invention will be apparent from the following detailed description, taken in conjunction with the accompanying drawings that illustrate, by way of example, various features of embodiments of the invention.

### BRIEF DESCRIPTION OF THE DRAWINGS

FIG. 1 is an explanatory outside perspective view of a drive unit for a CD-ROM or a DVD to which a device in accordance with an embodiment of the present invention is applied.

FIG. 2 is an explanatory longitudinal cross sectional view of a motor with an automatic balancing device, which is used in the drive unit for a CD-ROM or DVD shown in FIG. 1, in accordance with an embodiment of the present invention.

FIG. 3 is an explanatory longitudinal cross sectional view, which shows a constructional example of a rotational driving device with a conventional automatic balancing device.

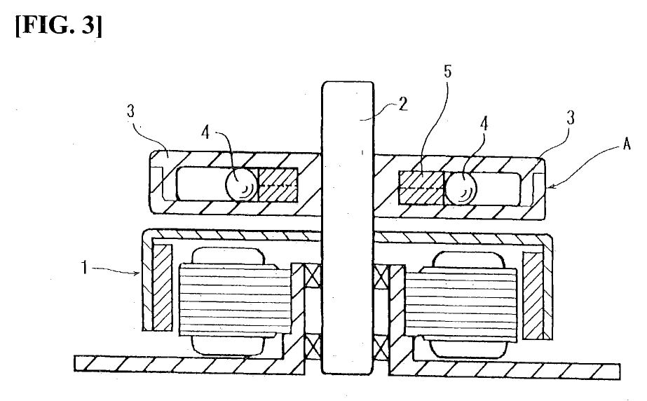

### DETAILED DESCRIPTION OF THE PREFERRED EMBODIMENTS

Preferred embodiments of the present invention will be described in detail below with reference to the accompanying drawings. A description will be made first as to an overview of a drive unit for a CD-ROM or a DVD as an example to which an automatic balancing device according to the present invention is applied.

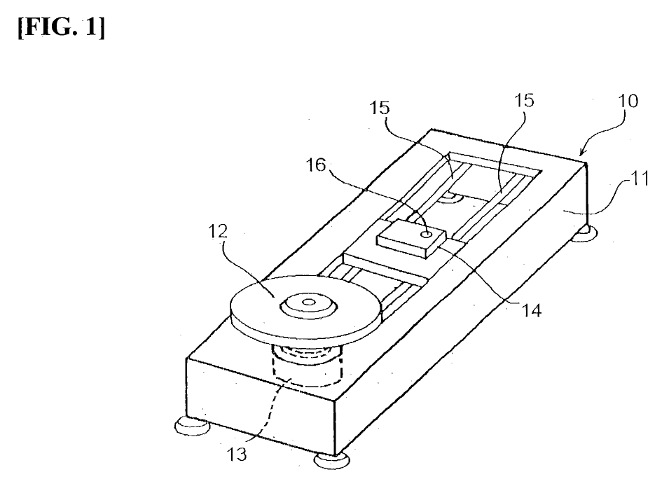

A spindle motor part 13 for rotating a record disk 12 and an optical pickup device 14 for writing or reading information by irradiating the record disk 12 with a laser beam are mounted on a mechanical chassis 11 of a CD-ROM drive unit 10 shown in FIG. 1.

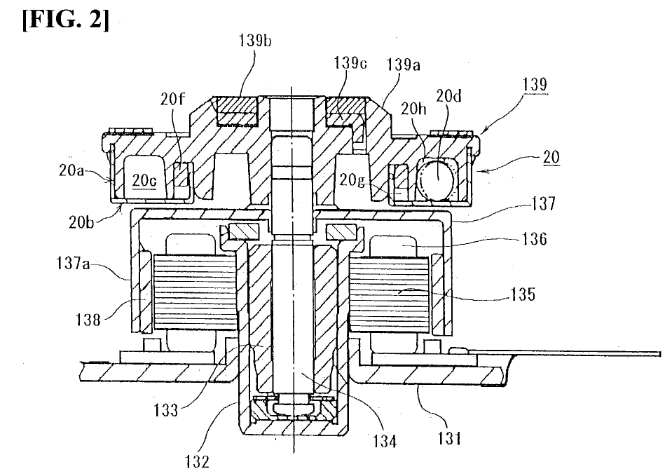

The record disk 12 is placed on a disk table (see notational symbol 139 in FIG. 2), which is fixed to a rotary shaft of the spindle motor part 13. The optical pickup device 14 is mounted on a pair of parallel guide shafts 15 arranged on the mechanical chassis 11 so as to be movable in a reciprocating way. The optical pickup device 14 is constituted in such a manner that a light beam emitted from a laser beam light source not shown in the drawings is irradiated on the record disk 12 through an objective lens 16 and a reflected light beam from the record disk 12 is detected.

The spindle motor part 13 includes a hollow cylinder-shaped bearing holder 132, which is installed so as to rise in a substantially perpendicularly manner with respect to a main body frame 131 as shown in FIG. 2. A bearing member 133 is installed within the hollow bearing holder 132 by press fitting. The bearing member 133 is provided with two bearing parts separated in an axial direction. Various types of bearing members such as an oil retaining slide bearing, ball bearing, metal bearing or a dynamic pressure bearing device can be utilized as the bearing member 133.

The rotary shaft 134 is rotatably supported by the bearing member 133 in a center portion of the bearing holder 132. A stator core 135, which consists of a laminated body formed with silicon steel plates or the like, is fitted on a circumferential wall face on the outer peripheral side of the bearing holder 132. An insulating layer is formed on the surface of the stator core 135 by coating. Coil windings 136 are respectively wound around respective salient pole parts of the stator core 135 via the insulating layer.

At an upper position of the bearing holder 132 in FIG. 2, a center portion of a nearly cup-shaped rotor case 137 formed in a substantially hollow cylindrical shape is fixed to the rotary shaft 134 by press fitting or the like. A rotor magnet 138 formed in a ring shape is fixed on an inner circumference surface of an annular circumferential wall part 137a, which is an outer peripheral portion of the rotor case 137. The inner circumference surface of the rotor magnet 138 is disposed so as to face the respective salient pole parts of the stator core 135 from an outward side in the radial direction.

A circular disk table (turntable) 139 made of a resin material (PC) is fixed to a protruding portion on an upper side of the rotary shaft 134 in the drawing. The disk table 139 is fixed to the rotary shaft 134 by press-fitting the rotary shaft 134 into a mounting hole formed in a center portion of the disk table 139. A record disk (see notational symbol 12 in FIG. 1) placed on the disk table 139 is held in a positioned state at a prescribed location by means of a substantially conical-shaped positioning protrusion part 139a, which is formed in a projecting manner toward an upward side from the fixed portion described above. A chucking magnet 139b formed in a ring and plate shape is mounted on a top part of the positioning protrusion part 139a via a yoke plate 139c.

The chucking magnet 139b is arranged so as to be exposed toward upper side in the drawing from a center hole of the record disk 12, which is positioned by the above-mentioned positioning protrusion 139a. The chucking magnet 139b is provided to magnetically attract and hold a magnetic pressure ring provided on a pressurizing member not shown in the drawings, which is used to press the record disk 12.

An automatic balancing device 20 for canceling a rotational imbalance of a rotary body including the rotor case 137 and the rotary shaft 134 described above is installed at a position directly below the disk table 139 in an axial direction. The automatic balancing device 20 is constituted so as to provide a function for canceling a rotational imbalance generated in the rotary body by means of a balancing effect owing to a mass movement when the number of revolutions of the motor part 13 exceeds the resonance rotation speed CR of the rotary body. A hollow housing case body 20c includes an upper ring-shaped annular member 20a in a nearly cup shape, which is made of a resin material (PC) in a integral manner with the disk table 139, and a lower ring-shaped annular member 20b formed with a pressed product of nonmagnetic material. The upper ring-shaped annular member 20a and the lower ring-shaped annular member 20b are fitted in such a manner that respective opening portions are opposed to each other in the axial direction in the drawing to constitute the sealed hollow housing case body 20c. Therefore, a sealed annular space is formed in the inside of the hollow shaped housing case body 20c by abutting the lower end face portion of the upper ring-shaped annular member 20a against the flat face portion of the lower ring-shaped annular member 20b or by tightly fitting the side face portion of the upper ring-shaped annular member 20a to the side face portion of the lower ring-shaped annular member 20b.

The hollow housing case body 20c formed in this way by being integrally rotated with the disk table 139. The sealed annular space is formed in the inside of the hollow housing case body 20c for accommodating a plurality of balance balls 20d. The balance balls 20d, each of which is a mass body having magnetism, are accommodated in the annular space of the hollow housing case body 20c in a freely movable manner in a circumferential and radial direction. For this purpose, the annular space of the hollow housing case body 20c has a larger width and height than that of the balance ball.

The balance ball 20d is formed with a material having magnetism but with residual magnetism as less as possible, for example, a steel ball such as a chrome steel. Preferably, a high-carbon chrome steel, referred to as SUJ-2, having a composition which consists of 0.95-1.10% C, 0.15-0.35% S, ≦0.50% Mn, ≦0.025% P, ≦0.025% S, 1.30-1.60% Cr, ≦0.08% Mo, and the balance Fe with inevitable impurities, is used. The respective balance balls 20d are put into the annular space formed by a lower ring-shaped annular member 20b and an upper ring-shaped annular member 20a so as to be freely movable in the radial and circumferential direction along a bottom flat face portion of the lower ring-shaped annular member 20b and side wall portions of the upper ring-shaped annular member 20a. By this constitution, a canceling operation of the rotary body including the above-mentioned rotor case 137, the rotary shaft 134 and the like is performed.

In other words, when the spindle motor part 13 is rotated at an appropriate speed of rotation exceeding the number of resonant rotation CR of the rotary body, the balance balls are moved in an opposite direction with respect to the position of the center of gravity of the rotary body. This movement enables to adjust the mass by moving the balls outside in the radial direction to cancel the rotation imbalance of the rotary body as shown with the two-dot chain line in FIG. 2. Accordingly, the rotation imbalance of the rotary body is lowered and the vibration of the rotary body is reduced. Therefore, stabilization of the rotation of the rotary body is attained.

A ring-shaped hold magnet (magnet body) 20f for attracting the respective balance balls 20d toward the center side is mounted on an inner periphery portion of the hollow housing case body 20c. The hold magnet 20f is a single-pole magnetized in the radial direction to magnetically attract the respective balance balls 20d on the inner side wall portion during low speed rotation up to an appropriate operation speed of rotation, which is the speed that the speed of rotation of the spindle motor part 13 does not exceed the number of resonant rotation CR. Therefore, while the motor part 13 is rotated at the low speed, the respective balance balls 20d are attracted and kept contacting with the inner side wall portion of the upper ring-shaped annular member 20a.

When the speed of rotation of the rotary body exceeds the number of resonant rotation CR, the balance balls 20d are separated from the inner side wall part of the upper ring-shaped annular member 20a by a centrifugal force against the attracting force of the hold magnet 20f to allow to move toward an outside position in the radial direction for canceling the imbalance. In this case, the balance balls 20d are repulsive to each other by means of a magnetic flux generated from the hold magnet 20f and thereby a noise due to the collision of the balance balls 20d is prevented.

A film of a volatile rust preventing agent is formed in a thin layered shape on the surface of the respective balance balls 20d. The volatile rust preventing agent is in the form of a white crystalline powder and made of a material such as cyclohexylamine nitrite, diisopropylamine nitrite, or cyclohexylammonium cyclohexylcarbamate. For example, like an insect repellent such as naphthalin or camphor, the volatile rust preventing agent is slowly vaporized at room temperature and the vaporized gas is attached on the surface of the respective balance balls 20d to form the thin film of the volatile rust preventing agent.

The thickness of the thin film of the volatile rust preventing agent is preferably set to be, for example, in a range of 1×10⁻¹¹˜1×10⁻⁶ m (meter) in order to obtain satisfactory sliding or rolling characteristic. The volatile rust preventing agent may be directly attached in a thin film shape on the surface of the respective balance balls 20d. Also, the thin film may be indirectly formed on the surface of the respective balance balls 20d by using the hold magnet 20f into which the volatile rust preventing agent is impregnated. In this case, the volatile rust preventing agent is vaporized at room temperature and the vaporized gas is filled in the annular space formed in the hollow housing case body 20c where the balance balls 20d are accommodated. The vaporized volatile rust preventing agent is allowed to make its layer on the surface of the respective balance balls 20d indirectly.

Next, a manufacturing method for an automatic balancing device according to an embodiment of the present invention will be described.

First, a manufacturing method for directly attaching a volatile rust preventing agent to form a thin film on the surface of the balance ball 20d will be described. Since the balance ball 20d formed with a chrome steel ball or the like is liable to be easily rusted, it is preserved and stored in a rust preventive oil with high viscosity before being used, for example, when it has been delivered. Accordingly, first of all, the balance ball 20d, which is delivered in the state preserved in the rust preventive oil, is put into an appropriate cleaning liquid and a degreasing and cleaning process is performed, for example, by applying an ultrasonic wave to remove the rust preventive oil adhered on the surface of the balance ball 20d.

Subsequently, the balance ball 20d after having finished the degreasing and cleaning process is left alone in an atmosphere of the volatile rust preventing agent for drying the cleaning liquid from the surface of the balance ball 20d and forming a thin film of the volatile rust preventing agent. In the present embodiment, an endothermical evaporating effect at the time of drying the cleaning liquid from the surface of the balance ball 20d, which is under an easily reacting condition, is utilized to form the film of the volatile rust preventing agent. In the conventional drying process after cleaning, the cleaning liquid is endothermically evaporated and dew condensation forms on the surface of the balance ball, which causes rust. On the other hand, in the present embodiment, the vapor of the volatile rust preventing agent which is slowly vaporized at room temperature is attached on the surface of the balance ball 20d instead of forming the dew condensation. Accordingly, the conventional occurrence of rust due to dew condensation is prevented.

The balance balls 20d on which the film of the volatile rust preventing agent is formed as the above-mentioned way is assembled so as to be accommodated in the annular space of the previously described hollow housing case body 20c.

In accordance with the embodiment of the present invention, the surface of the balance ball 20d is provided with the attached vapor of the volatile rust preventing agent, which was slowly vaporized at room temperature, and the film of the volatile rust preventing agent is formed in a uniform and thin film shape. Therefore, the rust preventing and the vibrational restraint of the balance ball 20d can be performed in an extremely satisfactory state. Therefore, a chrome steel having adequate magnetism and less residual magnetism can be used as the balance ball 20d even though the chrome steel in itself is liable to be rust.

Next, another embodiment to form a layer of the volatile rust preventing agent indirectly on the surface of the balance ball 20d will be described below. Also in this case, the balance balls 20d, which are delivered in the state preserved in the rust preventive oil, are put into an appropriate cleaning liquid and performed degreasing and cleaning process, for example, by applying an ultrasonic wave to remove the rust preventive oil adhered on the surface of the respective balance balls 20d. The balance balls 20d are then put and accommodated in the annular space of the hollow shaped housing case body 20c without being formed with the film of the volatile rust preventing agent.

In the automatic balancing device 20 according to the present embodiment, the ring-shaped hold magnet 20f is impregnated with the volatile rust preventing agent beforehand. Also, in the previously described automatic balancing device 20, the sealed annular space is constituted with the annular space 20g in which the ring-shaped hold magnet 20f is disposed and the annular space 20h in which the balance balls 20d are placed. In other words, the annular space 20g and the annular space 20h are communicated with each other by a plurality of through-holes not shown in the drawings. However, the annular space 20h and the annular space 20g are formed to be a sealed and communicated space by forming the annular space 20g also in a sealed state.

In the present embodiment having such a constitution, the hold magnet 20f is impregnated with the above-mentioned volatile rust preventing agent. In other words, the hold magnet 20f is impregnated with the volatile rust preventing agent in advance by means of similar processes as described above. Then, the hold magnet 20f impregnated with the volatile rust preventing agent is disposed within the annular space 20g of the hollow housing case body 20c.

As described above, the annular space 20h accommodating the balance balls 20d is communicated with the annular space 20g disposed with the hold magnet 20f through a plurality of through-holes. Accordingly, the volatile rust preventing agent vaporizes from the hold magnet 20f at room temperature, passes through the through-holes and flows into the annular space 20h. Therefore, the volatile rust preventing agent is filled in the annular space 20h. Then the vaporized volatile rust preventing agent is attached on the surface of the balance ball 20d to form the thin film of the volatile rust preventing agent.

Further, the vapor of the volatile rust preventing agent which is vaporized from the hold magnet 20f is filled into the annular space 20h through the through-holes, and the surface of the annular space 20h, that is, the inner and outer side wall portions of the upper ring-shaped annular member 20a and the flat face portion of the lower ring-shaped annular member 20b, is attached with the vaporized volatile rust preventing agent to form the thin film of the volatile rust preventing agent. This means that the thin film of the volatile rust preventing agent is formed on a face on which the balance balls 20d move or contact, and thus the rust prevention and vibrational restraint can be obtained in a furthermore satisfactory state.

In this manufacturing embodiment of the present invention, the film of the volatile rust preventing agent is indirectly formed on the surface of the balance ball 20d in a uniform and thin film shape, and similar operation and effects as the above-mentioned embodiment can be obtained. Consequently, a chrome steel having adequate magnetism and less residual magnetism can be used as the balance ball 20d.

Further, in the above-mentioned embodiment, it is possible to utilize both of the process in which the film of the volatile rust preventing agent is directly formed on the surface of the balance balls 20d and the process in which the film of the volatile rust preventing agent is indirectly formed on the surface of the balance balls 20d by using the hold magnet 20f impregnated with the volatile rust preventing agent.

The embodiments of the present invention are described above. However, needless to say, the present invention is not limited to the embodiments described above, and many modifications can be made without departing from the subject matter of the present invention.

For example, in the above-mentioned embodiment, the film of the volatile rust preventing agent is formed on the surface of the balance ball 20d. However, the film of the volatile rust preventing agent may be formed only on the surface of the case body, on which the balance balls 20d move or contact. Also in this case, similar operation and effects can be obtained.

As described above, in the automatic balancing device according to the present invention, the film of the volatile rust preventing agent is formed on the surface of the balance ball or the surface, on which the balance ball moves or contacts. Since the film of the volatile rust preventing agent can be formed in a uniform and thin film shape, the rust prevention for the balance ball and the vibrational restraint for the rotary body can be obtained in an extremely satisfactory state.

Further, in the automatic balancing device according to the present invention, the balance balls are respectively formed with a steel ball having magnetism, the hollow housing case body is arranged inside with a magnet body exerting magnetic action so that the respective steel balls can be repulsive to each other, and the magnet body is impregnated with a volatile rust preventing agent. Therefore, the film of the volatile rust preventing agent can be formed in a uniform and thin film shape on the surface of the balance ball or the surface of the annular space in which the balance balls are accommodated, after the automatic balancing device is assembled. Accordingly, the film of the volatile rust preventing agent is formed even though ordinary assembling processes are performed, and thus the rust prevention for the balance balls and vibrational restraint for the rotary body can be obtained in an extremely satisfactory state.

Also, in the manufacturing method for an automatic balancing device according to the present invention, there is provided a step of cleaning balance balls immersed in a rust preventive oil, a step of placing the balance balls in an atmosphere of a volatile rust preventing agent, and a step of forming a film of the volatile rust preventing agent on the surface of the respective balance balls, and then the balance balls are accommodated in an annular space of a hollow housing case body. Therefore, the film of the volatile rust preventing agent can be formed in a uniform and thin film shape, and thus the rust prevention for the balance balls and the vibrational restraint for the rotary body can be obtained in an extremely satisfactory state.

Further, in the another manufacturing method for an automatic balancing device according to the present invention, there is provided a step of providing a plurality of balance balls respectively formed with a steel ball having magnetism, a step of providing a hollow housing case body having a sealed annular space provided with an annular space for the steel balls and an annular space capable of disposing a magnet body for exerting magnetic action so that the steel balls are repulsive to each other, the two annular spaces being formed so as to be communicated with each other, a step of providing the magnet body in advance impregnated with a volatile rust preventing agent and disposed in the annular space of the hollow housing case body, and a step of forming a film of the volatile rust preventing agent on the surface of the respective balance balls or the surface on which the balance balls move by utilizing the volatile rust preventing agent impregnated in the magnet body. Therefore, the film of the volatile rust preventing agent can be formed even though ordinary assembling processes are performed, and thus the rust prevention for the balance balls and the vibrational restraint for the rotary body can be obtained in an extremely satisfactory state.

While the description above refers to particular embodiments of the present invention, it will be understood that many modifications may be made without departing from the spirit thereof The accompanying claims are intended to cover such modifications as would fall within the true scope and spirit of the present invention.

The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

What is claimed is:

1. An automatic balancing device comprising:
a hollow housing case body rotated with a rotary body and having an annular space formed inside of the hollow housing case body;
a plurality of balance balls accommodated in the annular space of the hollow housing case body in a freely movable manner so as to cancel an imbalance of the rotary body; and
a film of a volatile rust preventing agent formed on a surface of the plurality of balance balls.

2. The automatic balancing device according to claim 1, wherein the annular space of the hollow housing case body in which the balance balls are accommodated is formed in a sealed state and the volatile rust preventing agent is contained in a vaporized state in the sealed annular space.

3. The automatic balancing device according to claim 1, wherein the balance ball are formed of chrome steel.

4. The automatic balancing device according to claim 1, further comprising a magnet body disposed in a space formed in the hollow housing case body, and the balance balls are respectively formed with steel having a magnetism, the magnet body exerts magnetic action so that the steel balls can be repulsive to each other, the space in which the magnet body is disposed and the annular space in which the balance balls are accommodated are in communication with each other, and the magnet body is impregnated with the volatile rust preventing agent.

5. An automatic balancing device comprising:
a hollow housing case body rotated with a rotary body and having an annular space formed inside of the hollow housing case body;
a plurality of balance balls accommodated in the annular space of the hollow housing case body in a freely movable manner so as to cancel an imbalance of the rotary body; and
a film of a volatile rust preventing agent formed on at least a surface on which the plurality of balance balls move.

6. The automatic balancing device according to claim 5, wherein the film of the volatile rust preventing agent is formed on nearly an entire surface of the annular space of the hollow housing case body.

7. The automatic balancing device according to claim 6, wherein the annular space of the hollow housing case body in which the balance balls are accommodated is formed in a sealed state.

8. A manufacturing method for an automatic balancing device comprising:
providing a hollow housing case body rotated with a rotary body and having an annular space formed inside of the hollow housing case body;
cleaning a plurality of balance balls immersed in a rust preventive oil;
placing the balance balls in an atmosphere of a volatile rust preventing agent;
forming a film of the volatile rust preventing agent on a surface of the plurality of balance balls; and
putting the balance balls into the annular space of the hollow housing case body.

9. The manufacturing method for an automatic balancing device according to claim 8, further comprising forming the film of the volatile rust preventing agent on the surface of the plurality of balance balls at a time of drying the balance balls after cleaning, which is in an easy reaction state.

10. A manufacturing method for an automatic balancing device comprising:
providing a hollow housing case body rotated with a rotary body and having an annular space formed inside of the hollow housing case body;
providing a plurality of balance balls made with steel and having a magnetism;
providing a magnet body for exerting magnetic action so that the balance balls can be repulsive to each other;
impregnating a volatile rust preventing agent in the magnet body; and
disposing the magnet body impregnated with the volatile rust preventing agent in a space communicated with the annular space in which the balance balls are accommodated.

11. The manufacturing method for an automatic balancing device according to claim 10, further comprising:
cleaning the balance balls immersed in a rust preventive oil;
placing the balance balls in an atmosphere of a volatile rust preventing agent;
forming a film of the volatile rust preventing agent on a surface of the balance balls; and
putting the balance balls into the annular space of the hollow housing case body.

12. The automatic balancing device according to claim 1, wherein the hollow housing case body includes an upper ring-shaped annular member.

13. The automatic balancing device according to claim 5, wherein the hollow housing case body includes an upper ring-shaped annular member.

14. The automatic balancing device according to claim 12, wherein the upper ring-shaped annular member has a cup shape.

15. The automatic balancing device according to claim 13, wherein the upper ring-shaped annular member has a cup shape.

16. The automatic balancing device according to claim 12, wherein the upper ring-shaped annular member is made of a resin material.

17. The automatic balancing device according to claim 13, wherein the upper ring-shaped annular member is made of a resin material.

18. The automatic balancing device according to claim 1, wherein a height and width of the hollow housing case body is larger than a height and width of the plurality of balance balls.

19. The automatic balancing device according to claim 5, wherein a height and width of the hollow housing case body is larger than a height and width of the plurality of balance balls.

20. The manufacturing method for an automatic balancing device according to claim 8, further comprising forming a height and width of the hollow housing case body larger than a height and width of the plurality of balance balls.
